(19) United States
(12) Patent Application Publication
(10) Pub. No.: US 2013/0084395 A1
(43) Pub. Date: Apr. 4, 2013

(54) Treatment of Plastic Surfaces After Etching in Nitric Acid Containing Media

(71) Applicants: Roshan V. Chapaneri, Foleshill Coventry (GB); Anthony Wall, Oldbury West Midlands (GB); Trevor Pearson, Cradley Health West Midlands (GB); Roderick D. Herdman, Staffordshire (GB)

(72) Inventors: Roshan V. Chapaneri, Foleshill Coventry (GB); Anthony Wall, Oldbury West Midlands (GB); Trevor Pearson, Cradley Health West Midlands (GB); Roderick D. Herdman, Staffordshire (GB)

(21) Appl. No.: 13/248,550

(22) Filed: Sep. 29, 2011

(51) Int. Cl. B05D 3/10

(52) U.S. Cl. 427/306; 427/304

(57) ABSTRACT

A process for plating metal on plastic substrates, particularly ABS substrates, without the use of chrome containing etchants is disclosed. The process involves (i) etching the plastic substrate in an acidic solution of nitrate ions, and preferably silver ions, (ii) conditioning the substrate in an aqueous solution containing an amine or ammonia, (iii) activating the substrate, preferably with a palladium activator, and (iv) plating the substrate with an electroless plating solution. The process allows for complete adherent electroless plating of plastic substrates, particularly ABS substrates, without the use of chromic etchants.

### FIELD OF THE INVENTION

The present invention relates generally to the treatment of plastic surfaces following etching in an acidic solution containing nitrate ions.

### BACKGROUND OF THE INVENTION

For many years, processes have been available to facilitate the deposition of electrodeposited metals onto plastic substrates. A typical process involves the steps of:
(1) etching the plastic in a suitable etching solution such that the surface of the plastic becomes roughened and wetted so that the subsequently applied deposit has good adhesion;
(2) activating the surface of the plastic using a colloidal or ionic solution of a metal capable of initiating the deposition of an autocatalytically applied metal coating of typically copper or nickel;
(3) depositing a thin layer of autocatalytically applied metal; and
(4) carrying out electrodeposition of metal onto the metallized plastic substrate.
   Typically, layers of copper, nickel and/or chromium are applied to produce the final article.

The most widely used plastic substrates include acrylonitrile/butadiene/styrene copolymers (ABS) or ABS blended with polycarbonate (ABS/PC). These materials are readily formed into components by the process of injection molding. ABS comprises a relatively hard matrix of acrylonitrile/styrene copolymer and the butadiene polymerizes to form a separate phase. It is this softer phase of polybutadiene (which contains double bonds in the polymer backbone) which can be readily etched using various techniques.

Traditionally, the etching has been carried out using a mixture of chromic and sulfuric acids which must be operated at an elevated temperature. The chromic acid is capable of dissolving the polybutadiene phase of the ABS by oxidation of the double bonds in the backbone of the polybutadiene polymer, and this has proven to be reliable and effective over a wide range of ABS and ABS/PC plastics. However, the use of chromic acid is becoming increasingly regulated because of its toxicity and carcinogenic nature. For this reason, there has been a considerable amount of research into other means of etching ABS and ABS/PC plastics.

There are a number of approaches possible in order to attempt to achieve this. For example, acidic permanganate is capable of oxidizing the double bonds in the polybutadiene. Chain scission can then be achieved by further oxidation with periodate ions. Ozone is also capable of oxidizing polybutadiene and this approach has also been attempted. However, ozone is extremely dangerous to use and is also highly toxic. Likewise, sulfur trioxide can be successfully utilized to etch ABS, but this cannot be successfully achieved on a typical plating line. Other examples of prior art techniques for etching ABS plastics without the use of chromic acid can be found in U.S. Pat. Pub. No. 2005/0199587 to Bengston, U.S. Pat. Pub. No. 2009/0092757 to Sakou and U.S. Pat. No. 5,160,600 to Gordhanbai, the subject matter of each of which is herein incorporated by reference in its entirety. However, none of these methods have achieved widespread commercial acceptance.

Thus, there remains a need in the art for an improved process of etching plastics without chromic acid, while continuing to utilize a conventional activation process containing a palladium colloid followed by electroless nickel.

### SUMMARY OF THE INVENTION

It is an object of the present invention to provide a process for etching plastics without the use of chromic acid.

It is another object of the present invention to provide a process for etching acrylonitrile/butadiene/styrene copolymers without the use of chromic acid.

It is still another object of the present invention to provide an improved conditioning treatment for conditioning the surfaces of an etched plastic.

To that end, the present invention relates generally to a method of treating a plastic substrate to accept electroless plating thereon, the method comprising the steps of:
a) etching at least a surface of the plastic substrate by contacting the plastic substrate with an acidic solution containing nitrate ions;
b) contacting the etched plastic substrate with a conditioning solution comprising an aqueous solution comprising ammonia, an amine or combinations thereof;
c) activating the etched and conditioned plastic substrate; and
d) immersing the activated plastic substrate into an electroless metal plating solution to deposit metal thereon.

### BRIEF DESCRIPTION OF THE FIGURES

FIG. 1 depicts an infra-red analysis obtained from untreated ABS.

FIGS. 2A and 2B depict an infra-red analysis obtained from ABS treated with a chromic acid/sulfuric acid etch solution of the prior art.

FIGS. 3A and 3B depict an infra-red analysis obtained from ABS treated with an acidic solution of nitrate and silver ions.

FIGS. 4A and 4B depict an infra-red analysis obtained from ABS treated with an acidic solution of nitrate and silver ions and then post-treated in an ammonia solution.

### DETAILED DESCRIPTION OF THE PREFERRED EMBODIMENTS

In preliminary experiments using nitric acid/silver(II) etch compositions, the inventors of the present invention discovered that although this etch composition can be used to effectively etch an ABS or ABS/PC plastic to give an excellent surface topography, the subsequent catalysis of the surface could not be achieved and there was no deposition of nickel when the components were subsequently immersed in the electroless nickel plating process. Examination of the surface of the plastic using infrared spectroscopy indicates that the surface of the plastic has been chemically altered to some degree. New peaks were found following the etching stage, which almost disappeared when the plastic was immersed in hot water (80° C.) for 10 minutes. However, even though the surface of the plastic had apparently reverted in composition to something similar to its original composition, palladium adsorption and subsequent catalyzation of the surface could not be achieved.

Surprisingly, the inventors of the present invention have discovered that immersing the etched plastic in a solution containing amines can condition the surface so that palladium adsorption can be achieved. Without wishing to be bound by theory, the inventors consider that it is possible that the amines are adsorbed onto the surface of the etched plastic, thus imparting a positive charge on the surface of the plastic when immersed into the acidic palladium colloid solution. With primary, secondary and tertiary amines, this positive charge is most likely formed by protonation of the amines, and with quaternary amines, the positive charge is already present on the amine.

The inventors have also found, through infrared spectroscopy, that an etched plastic can be modified with an amine-based post treatment. In addition to the disappearance of the peaks introduced following the etching stage, a new functional group appears to have been introduced. The composition of the invention conditions the surface of the plastic so that effective palladium adsorption can be achieved in order to catalyze the subsequent deposition of autocatalytic metal deposits.

According to the present invention, a method is provided for the catalysis and subsequent metallization of plastics which have been etched in nitric acid containing solutions. In a preferred embodiment, the method of the invention comprises the following steps:
a) etching at least a surface of the plastic substrate by contacting the plastic substrate with an acidic solution containing nitrate ions;
b) contacting the etched plastic substrate with a conditioning solution comprising an aqueous solution comprising ammonia, an amine or combinations thereof;
c) activating the etched and conditioned plastic substrate; and
d) immersing the activated plastic substrate into an electroless metal plating solution to deposit metal thereon.
   Following the above steps, the metallized component can be electroplated in the usual manner.

The acidic etching solution preferably comprises nitric acid. In addition, other mineral acids such as sulfuric acid may also be added to the composition. In a preferred embodiment the acidic etching solution also contains oxidizing metallic ions of metals including, for example, silver, manganese, cobalt, cerium and combinations thereof, preferably in their highest oxidation state. Preferably, these ions are produced by a process of electrochemical oxidation. In addition, if desired, a wetting agent may also be added to the acidic etching solution. One suitable wetting agent is available from MacDermid, Inc. under the trade name Macuplex STR.

Thereafter, the etched plastic substrate is contacted with the conditioning solution. In one preferred embodiment the etched plastic substrate is immersed in the conditioning solution. The concentration of amines or ammonia in the aqueous conditioning solution is not critical but is preferably within the range of about 5 to about 100 g/L, more preferably in the range of about 10 to about 50 g/L. The pH of the solution may be from 0 to 14, but is preferably in the range of 6-12.

As discussed above, the amine may be a primary, secondary, tertiary or quarternary amine. In the alternative, the solution may comprise ammonia instead of the amine. In addition, it is also possible to use a combination of different amines or a combination of an amine with ammonia in the conditioning solution of the invention.

Suitable primary amines include, for example, monoethylamine, mono-n-propylamine, iso-propylamine, mono-n-butylamine, iso-butylamine, monoethanolamine, neopentanolamine, 2-aminopropanol, 3-aminopropanol, 2-hydroxy-2′(aminopropoxy)ethylether, 1-aminopropanol, monoisopropanolamine, diethylaminopropylamine, aminoethyl ethanolamine and combinations of the foregoing. In a preferred embodiment, the primary amine comprises monoisopropanolamine or diethylenetriamine.

Suitable secondary amines include, for example, diethylamine, dibutylamine, diethanolamine, methylethylamine, di-n-propanolamine, di-iso-propanolamine, N-methylethanolamine, N-ethylethanolamine, N-methylethanolamine, di-isopropanolamine, diethylenetriamine, triethylenetetramine, tetraethylenepentamine and combinations of the foregoing. In a preferred embodiment, the secondary amine comprises di-ethanolamine or diethylenetriamine.

Suitable tertiary amines include, for example, N,N-dimethylethanolamine, triethylamine, trimethylamine, triisopropylamine, methyldiethanolamine, triethanolamine, and combinations of one or more of the foregoing. In a preferred embodiment, the tertiary amine comprises N,N-dimethylethanolamine.

Quarternary amines are also generally suitable, including quarternary (poly)amines. Suitable quarternary amines also include polymeric quarternary amines having the general formula:

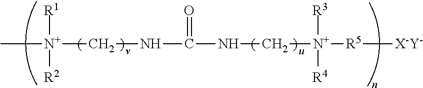

Wherein:

R¹, R², R³ and R⁴ independently can be the same or different and may be selected from —CH₃, —CH₂CH₃, —CH(CH₃)₂ or —CH₂CH₂OH;

R⁵ is —CH₂CH₂—, —CH₂CH₂CH₂—, —CH₂CH₂CH₂CH₂—, —CH₂CHOHCH₂— or —CH₂CH₂OCH₂CH₂;

X and Y can be the same or different and are selected from Cl, Br, and I;

v and u can be the same or different and each can be 1 to 7; and

n is 2 to about 200.

In one embodiment the polymeric quaternary amine is Mirapol™ WT (available from Rhodia) in which in the above formula:

R¹, R², R³ and R⁴ are each CH₃;

R⁵ is —CH₂CH₂OCH₂CH₂;

v and u are 3;

X and Y are Cl; and

n is an average of about 6.

Other suitable polymeric amines include polyethyleneimines such as Lugalvan™ G35 available from BASF.

The invention can now be illustrated by reference to the following non-limiting examples:

The following details apply to the examples:

POLYLAC™ PA727 is a commercial grade of acrylonitrile butadiene styrene (ABS) manufactured by Chi Mei, Inc., Taiwan.

The following products described in the examples are available from MacDermid, Inc. and were used in accordance with their product data sheets.

| Product | Description |
|---|---|
| ND7 Supreme ™ | Pre-etch cleaning/degreasing solution |
| Macuplex ™ STR | Wetting agent |
| Macuplex ™ 9338 | Neutralizing treatment for hexavalent |
| | chromium |
| Macuplex ™ D-34C | Activating solution based on |
| | colloidal suspension of metallic |
| | palladium particles in a stannous |
| | chloride medium |
| Macuplex ™ 9369 | Post-activator acidic treatment to |
| | improve the autocatalytic nature of |
| | the activated surface |
| Macuplex ™ J-64 | Elecfroless nickel plating bath |

### Infra-Red (IR) Instrument and Analysis Details:

Instrument—PerkinElmer spectrum 100 FTIR spectrometer

### Analysis Details:

Attenuated total reflectance (ATR) mode
Wavenumber range—4000-6000 cm⁻¹
Number of scans—8

### EXAMPLE 1

### Untreated POLYLAC™ PA727

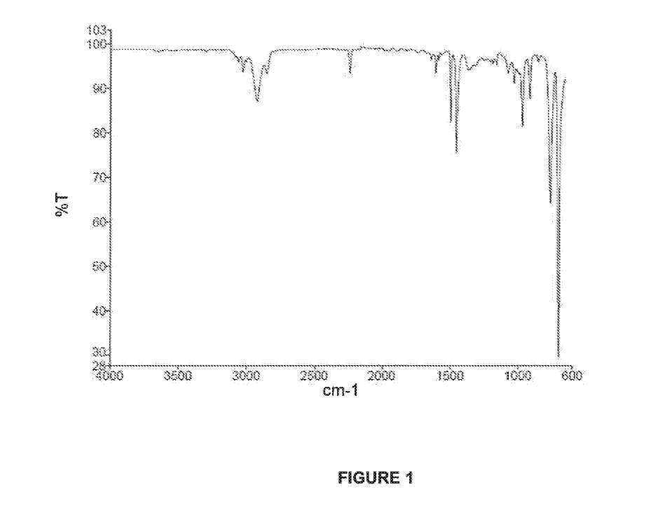

The Infra-Red analysis obtained from untreated ABS is shown in FIG. 1.

### EXAMPLE 2

### POLYLAC™ PA727 Processed Through a Chromic Acid/Sulfuric Etch Solution of the Prior Art.

| | | Temperature | |
|---|---|---|---|
| Process | Details | (° C.) | Time |
| ND7 Supreme ™ | | 50 | 2 minutes |
| Water rinse | | Ambient | 1 minute |
| Etch | 4 M chromic acid | 68 | 7 minutes |
| | 3.6 M sulfuric acid | | |
| | 1 ml/l Macuplex | | |
| | STR | | |
| Water rinse | | Ambient | 2 minutes |
| Macuplex ™ 9338 | | 30 | 2 minutes |
| Water rinse | | Ambient | 1 minute |
| Dry | | | |
| Infra-Red analysis | | | |

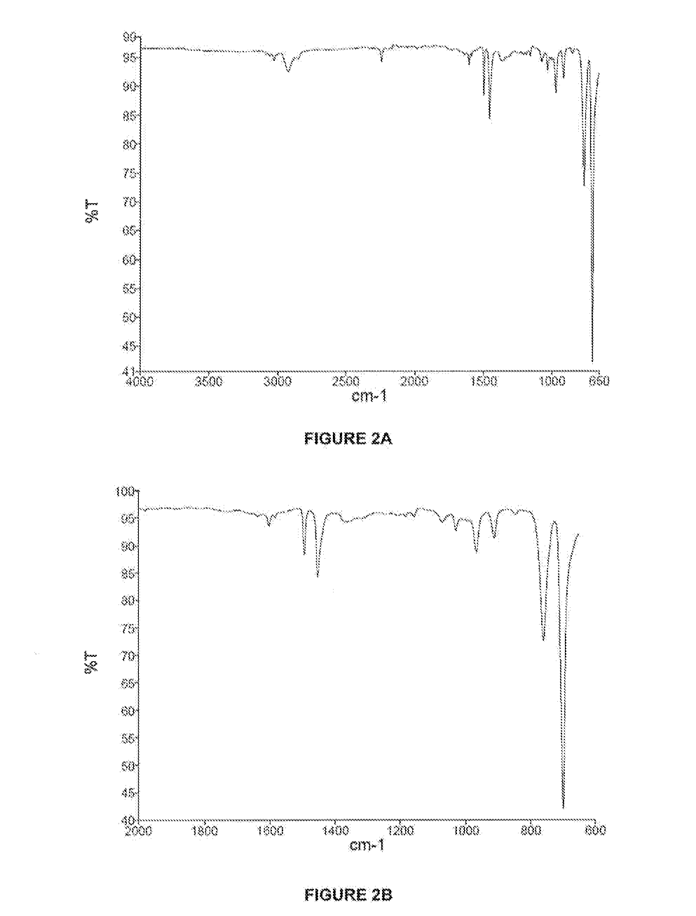

The infra-red spectrum obtained is shown in FIGS. 2A and 2B.

In the following examples 3-9, the chromium free etch solution is contained in a 2-compartment glass cell separated by a glass frit, with the etching solution being the anolyte (the catholyte being of the same composition with the exception of the silver nitrate being absent in the catholyte). The anode and cathode materials were platinized titanium mesh and the anodic current density used was 32.5 mA/cm². This system was used to electrochemically oxidize the silver ions to the +2 oxidation state.

A mechanical stirrer bar was used to provide agitation and the cell was electrolyzed by a minimum of two hours before use in order to generate a significant quantity of silver (II) ions.

### EXAMPLE 3

Example 3 illustrates an ABS substrate processed through non-chrome etch solution:

| Process | Details | Temperature (° C.) | Time |
|---|---|---|---|
| ND7 Supreme ™ | | 50 | 2 minutes |
| Water rinse | | Ambient | 1 minute |
| Etch | 0.1 M AgNO₃ | 50 | 6 minutes |
| | 9 M HNO₃ | | |
| | 7 ml/l Macuplex STR | | |
| Water rinse | | Ambient | 2 minutes |
| Dry | | | |
| Infra-Red analysis | | | |

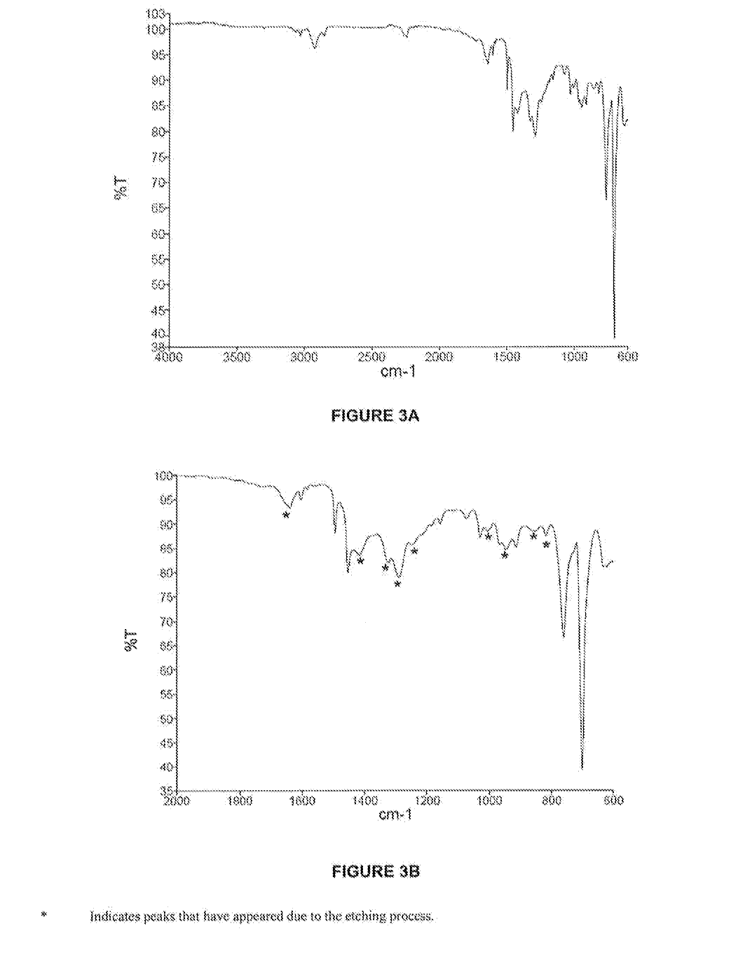

The infra-red spectrum obtained is shown in FIG. 3A and 3B. FIGS. 3A and 3B depict the FTIR spectrum of POLYLAC™ PA727 etched in an acidic solution containing nitrate ions and silver ions. FIG. 3A shows the results at 4000-600 cm⁻¹ and FIG. 3B shows the results at 2000-600 cm⁻¹. The “*” in the FIGS. 3A and 3B indicate peaks that have appeared due to the etching process.

### EXAMPLE 4

Example 4 illustrates an ABS substrate processed through a non-chrome etch solution and an ammonia post-treatment solution.

| Process | Details | Temperature (° C.) | Time |
|---|---|---|---|
| ND7 Supreme ™ | | 50 | 2 minutes |
| Water rinse | | Ambient | 1 minute |
| Etch | Same as Example 3 | 50 | 6 minutes |
| Water rinse | | Ambient | 2 minutes |
| Ammonia treatment | 40 ml/l of 0.880 SG | 50 | 5 minutes |
| | ammonia solution | | |
| | (or 0.68 M NH₃) | | |
| Water rinse | | Ambient | 1 minute |
| Dry | | | |
| Infra-Red analysis | | | |

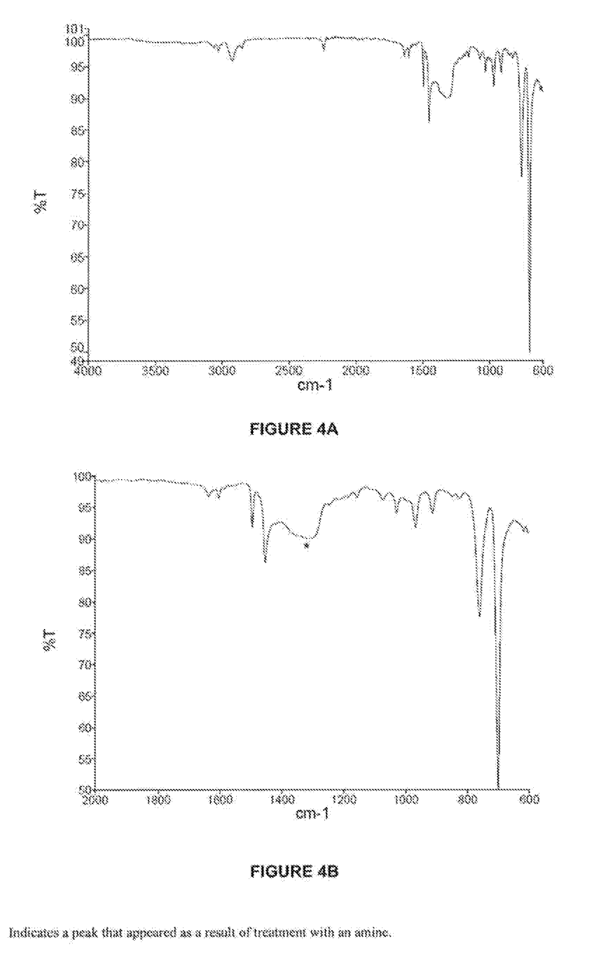

The infra-red spectrum obtained is shown in FIGS. 4A and 4B. FIGS. 4A and 4B depict the FTIR spectrum of POLYLAC™ PA727 etched in an acidic solution containing nitrate ions and silver ions and post treated in an ammonia solution. FIG. 4A shows the results at 4000-600 cm⁻¹ and FIG. 4B shows the results at 2000-600 cm⁻¹. As can be seen in FIGS. 4A and 4B, there is an absence of the peaks introduced in Example 3. In this example, the “s” in FIG. 4B indicates a new peak introduced by treatment with an amine.

### EXAMPLE 5

Example 5 illustrates an ABS substrate processed through a non-chrome etch solution an ammonia post-treatment solution and up to the electroless nickel stage:

| Process | Details | Temperature (° C.) | Time |
|---|---|---|---|
| ND7 Supreme ™ | | 50 | 2 minutes |
| Water rinse | | Ambient | 1 minute |
| Etch | Same as Example 3 | 50 | 6 minutes |
| Water rinse | | Ambient | 2 minutes |
| Ammonia treatment | 40 ml/l of 0.880 SG | 50 | 5 minutes |
| | ammonia solution | | |
| Water rinse | | Ambient | 1 minute |
| Acid rinse | 2.8 M HCl | Ambient | 1 minute |
| Macuplex ™ D-34C | | 27 | 3 minutes |
| Water rinse | | Ambient | 1 minute |
| Macuplex ™ 9369 | | 48 | 2 minutes |
| Water rinse | | Ambient | 1 minute |
| Macuplex ™ J-64 | | 32 | 7 minutes |
| Water rinse | | Ambient | 1 minute |
| Dry | | | |

The result was full electroless nickel metallization.

### EXAMPLE 6

Example 6 illustrates an ABS substrate processed through a non-chrome etch solution, deionized water post-treatment solution and up to the electroless nickel stage:

| | | Temperature | |
|---|---|---|---|
| Process | Details | (° C.) | Time |
| ND7 Supreme ™ | | 50 | 2 minutes |
| Water rinse | | Ambient | 1 minute |
| Etch | 0.1 M AgNO₃ | 55 | 6 minutes |
| | 6 M HNO₃ | | |
| | 6 M H₂SO₄ | | |
| | 1 ml/l Macuplex STR | | |
| Water rinse | | Ambient | 5 minutes |
| Hot water rinse | | 80 | 10 minutes |
| Water rinse | | Ambient | 1 minute |
| Acid rinse | 2.8 M HCl | Ambient | 1 minute |
| Macuplex ™ D-34C | | 27 | 3 minutes |
| Water rinse | | Ambient | 1 minute |
| Macuplex ™ 9369 | | 48 | 2 minutes |
| Water rinse | | Ambient | 1 minute |
| Macuplex ™ J-64 | | 32 | 7 minutes |
| Water rinse | | Ambient | 1 minute |
| Dry | | | |

The result was no electroless nickel metallization.

### EXAMPLE 7

Example 7 illustrates an ABS substrate processed through a non-chrome etch solution, a N,N-dimethylethanolamine post treatment solution and up to the electroless nickel stage:

| | | Temperature | |
|---|---|---|---|
| Process | Details | (° C.) | Time |
| ND7 Supreme ™ | | 50 | 2 minutes |
| Water rinse | | Ambient | 1 minute |
| Etch | Same as Example 6 | 55 | 6 minutes |
| Water rinse | | Ambient | 2 minutes |
| Amine treatment | 10 g/L N,N- | 80 | 10 minutes |
| | dimethylethanolamine | | |
| Water rinse | | Ambient | 1 minute |
| Acid rinse | 2.8 M HCl | Ambient | 1 minute |
| Macuplex ™ D-34C | | 27 | 3 minutes |
| Water rinse | | Ambient | 1 minute |
| Macuplex ™ 9369 | | 48 | 2 minutes |
| Water rinse | | Ambient | 1 minute |
| Macuplex ™ J-64 | | 32 | 7 minutes |
| Water rinse | | Ambient | 1 minute |
| Dry | | | |

The result was full electroless nickel metallization.

### EXAMPLE 8

Example 8 illustrates an ABS substrate processed through a non-chrome etch solution, a diethylene triamine post treatment solution and up to the electroless nickel stage:

| Process | Details | Temperature (° C.) | Time |
|---|---|---|---|
| ND7 Supreme ™ | | 50 | 2 minutes |
| Water rinse | | Ambient | 1 minute |
| Etch | 0.1 M AgNO₃ | 55 | 12 minutes |
| | 6 M HNO₃ | | |
| | 3 M H₂SO₄ | | |
| Water rinse | | Ambient | 2 minutes |
| Amine treatment | 15 g/L diethylene | 50 | 5 minutes |
| | triamine | | |
| Water rinse | | Ambient | 1 minute |
| Acid rinse | 2.8 M HCl | Ambient | 1 minute |
| Macuplex ™ D-34C | | 27 | 3 minutes |
| Water rinse | | Ambient | 1 minute |
| Macuplex ™ 9369 | | 48 | 2 minutes |
| Water rinse | | Ambient | 1 minute |
| Macuplex ™ J-64 | | 32 | 7 minutes |
| Water rinse | | Ambient | 1 minute |
| Dry | | | |

The result was full electroless nickel metallization.

### EXAMPLE 9

Example 9 illustrates an ABS substrate processed through a non-chrome etch solution, a polymeric quaternary amine post treatment solution and up to the electroless nickel stage:

| Process | Details | Temperature (° C.) | Time |
|---|---|---|---|
| ND7 Supreme ™ | | 50 | 2 minutes |
| Water rinse | | Ambient | 1 minute |
| Etch | Same as Example 8 | 50 | 6 minutes |
| Water rinse | | Ambient | 2 minutes |
| Amine treatment | 15 g/L Mirapol WT, a | 50 | 5 minutes |
| | polymeric quaternary | | |
| | amine available from | | |
| | Rhodia | | |
| Water rinse | | Ambient | 1 minute |
| Acid rinse | 2.8 M HCl | Ambient | 1 minute |
| Macuplex ™ D-34C | | 27 | 3 minutes |
| Water rinse | | Ambient | 1 minute |
| Macuplex ™ 9369 | | 48 | 2 minutes |
| Water rinse | | Ambient | 1 minute |
| Macuplex ™ J-64 | | 32 | 7 minutes |
| Water rinse | | Ambient | 1 minute |
| Dry | | | |

The result was full electroless nickel metallization.

What is claimed is:

1. A method of treating a plastic substrate to accept electroless plating thereon, the method comprising the steps of:
a) etching a surface of the plastic substrate by contacting the plastic substrate with an acidic solution containing nitrate ions;
b) contacting the etched plastic substrate with a conditioning solution comprising an aqueous solution comprising ammonia, an amine or combinations thereof;
c) activating the plastic substrate; and
d) contacting the activated plastic substrate with an electroless metal plating solution to deposit metal thereon.

2. The method according to claim 1, wherein the acidic solution comprises oxidizing metal ions.

3. The method according to claim 2, wherein the acidic solution comprises silver nitrate and nitric acid.

4. The method according to claim 3, wherein the acidic solution comprises a wetting agent.

5. The method according to claim 1, comprising the step of immersing the plastic substrate into an acid rinse after step (b).

6. The method according to claim 1, wherein the amine comprises at least one of a primary amine, a secondary amine, a tertiary amine and a quaternary amine.

7. The method according to claim 6, wherein the primary amine is selected from the group consisting of monoethylamine, mono-n-propylamine, iso-propylamine, mono-n-butylamine, iso-butylamine, monoethanolamine, neopentanolamine, 2-aminopropanol, 3-aminopropanol, 2-hydroxy-2′(aminopropoxy)ethylether, 1-aminopropanol, monoisopropanolamine, diethylaminopropylamine, 2-aminoethylethanolamine and combinations of the foregoing.

8. The method according to claim 7, wherein the primary amine comprises monoisopropanol amine.

9. The method according to claim 6, wherein the secondary amine is selected from the group consisting of diethylamine, dibutylaminc, diethanolamine, methylethylamine, di-n-propanolamine, iso-propanolamine, N-methylethanolamine, diethylenetriamine, N-ethylethanolamine, N-methylethanolamine, di-isopropanol amine, and combinations of the foregoing.

10. The method according to claim 9, wherein the secondary amine comprises diethanolamine.

11. The method according to claim 6, wherein the tertiary amine is selected from the group consisting of N,N-dimethylethanolamine, triethylamine, trimethylamine, triisopropylamine, methyldiethanolamine, triethanolamine and combinations of one or more of the foregoing.

12. The method according to claim 11, wherein the tertiary amine comprises N,N-dimethylethanolamine.

13. The method according to claim 9, wherein the tertiary amine comprises diethylenetriamine.

14. The method according to claim 6, wherein the quaternary amine comprises a polymeric quaternary amine having the general formula: 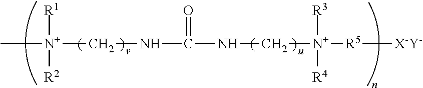
wherein:
R¹, R², R³ and R⁴ independently can be the same or different and may be selected from —CH₃, —CH₂CH₃, —CH(CH₃)₂ or —CH₂CH₂OH;
R⁵ is —CH₂CH₂—, —CH₂CH₂CH₂—, —CH₂CH₂CH₂CH₂—, —CH₂CHOHCH₂— or —CH₂CH₂OCH₂CH₂;
X and Y can be the same or different and are selected from Cl, Br, and I;
v and u can be the same or different and each can be 1 to 7; and
n is 2 to about 200.

15. The method according to claim 14, wherein in the polymeric quaternary amine,
R¹, R², R³ and R⁴ are each CH₃;
R⁵ is —CH₂CH₂OCH₂CH₂;
v and u are 3;
X and Y are Cl; and
n is an average of about 6.

16. The method according to claim 1 wherein the concentration of the amine and/or the ammonia in the conditioning solution is between about 5 and about 100 g/L.

17. The method according to claim 16, wherein the concentration of the amine and/or the ammonia in the conditioning solution is between about 10 and about 50 g/L.

18. The method according to claim 1, wherein the conditioning solution has a pH of between about 0 to about 14.

19. The method according to claim 18, wherein the conditioning solution has a pH of between about 6 and about 12.

20. The method according to claim 1, wherein the step of activating the etched and conditioned plastic substrate comprises contacting the plastic substrate with an activation solution comprising palladium.

21. The method according to claim 1, further comprising the step of contacting the activated plastic substrate with an acid treatment prior to step (d).

22. The method according to claim 1, wherein the electroless metal plating solution comprises electroless nickel.
